(19) United States
(12) Patent Application Publication
(10) Pub. No.: US 2003/0103643 A1
(43) Pub. Date: Jun. 5, 2003

(54) Amplifier with improved structure

(76) Inventor: Wen-Teng Yu, Tao-Yuan Hsien (TW)

Correspondence Address: David E Douherty, DENNISON SCHULTZ & DOUGHERTY, 612 Crystal Square 4, 1745 Jefferson Davis Highway, Arlington, VA, 22202, US

(21) Appl. No.: 10/002,226

(22) Filed: Dec. 5, 2001

(51) Int. Cl. H04R 1/02; H04R 1/00; H04R 9/06; H04R 11/02

(52) U.S. Cl. 381/433; 381/386

(57) ABSTRACT

An improved structure of amplifier, the amplifier consists of a frame, a base fixed at the bottom of the frame, one or more than one magnet, a spacer, a T-shaped iron, a package component containing one or more than one damper, a cone paper, a heat sink, a rubber edge, a dust cap, a voice coil, a fixed tube, the package component is placed inside the frame, the frames is featured by its one-body structure which is produce by injection molding and made of rubber material.

### BACKGROUND OF THE INVENTION

The present invention relates to an amplifier with improved structure, and more particularly to a new method for manufacturing frame. Only one die is used in this method which doesn't limit the shape of the frame, total cost can also be reduced.

Generally speaking, there are many kinds of methods for producing amplifier (also called speaker). The materials used for producing amplifier are usually aluminum, iron, or alloys. According to different purpose and function of amplifier, these manufacturing methods can be divided into press machining and casting. The material used for press machining is usually ferrous metal, but aluminum is usually used for casting. However, several dies are required to obtain an amplifier by die pressing. It means the more complicated the amplifier, the more dies are required to produce one amplifier, and the total cost increases. Another problem is the high density of ferrous material leads to undesirable resonance which consumes power unexpectedly. The problem of casting is higher production cost, time consuming, lower yield because of conventional porosity problem. Therefore, these two methods require a second manufacturing process to obtain the final product. The more process means the higher price which is not accepted by consumer.

Additionally, as shown in FIG. 1, FIG. 1 illustrates the cross-sectional view of a conventional amplifier. Some commercialized amplifiers contain a magnet driving unit 1 which consists of an upper spacer 10, a lower spacer 11 and a magnet 12, a frame 8, a voice coil 3 placed inside the frame 8, a cone 4, an edge 5, a damper 6, a dust cap 7. The lower spacer contains an axial shaft sticking out and penetrating through the magnet 12 and the iron core of the upper spacer 10 for the voice coil 3 to generate magnet effect. Thermosetting resin or thermoplastic material is used to form the frame 8 in a die by hot pressing or injection molding. Those components of the magnet driving unit 1 are put into die in suitable positions where they can be located at the bottom of the frame 8 after the frame 8 is formed. The material is then introduced into die to form a one-body system containing the frame 8 and the magnetic driving unit 1 located at the bottom of the frame 8. Voice coil 3, cone 4, edge 6, damper 6 are subsequently assembled together to form the amplifier. But the above mentioning process is to put the magnetic driving unit 1 into die and then perform hot pressing or injection molding in the die. As shown in FIG. 1, the frame is basically a one-body system. It is obviously difficult to design the frame structure and die no matter hot pressing or injection molding is going to be performed.

### SUMMARY OF THE INVENTION

Therefore, the object of the invention is to provide a better process for manufacturing amplifier. Injection molding process is used in the invention to produce a one-body frame structure which causes minimum resonance effect among conventional amplifiers made of aluminum or ferrous metal.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is the cross-sectional view of a conventional amplifier;

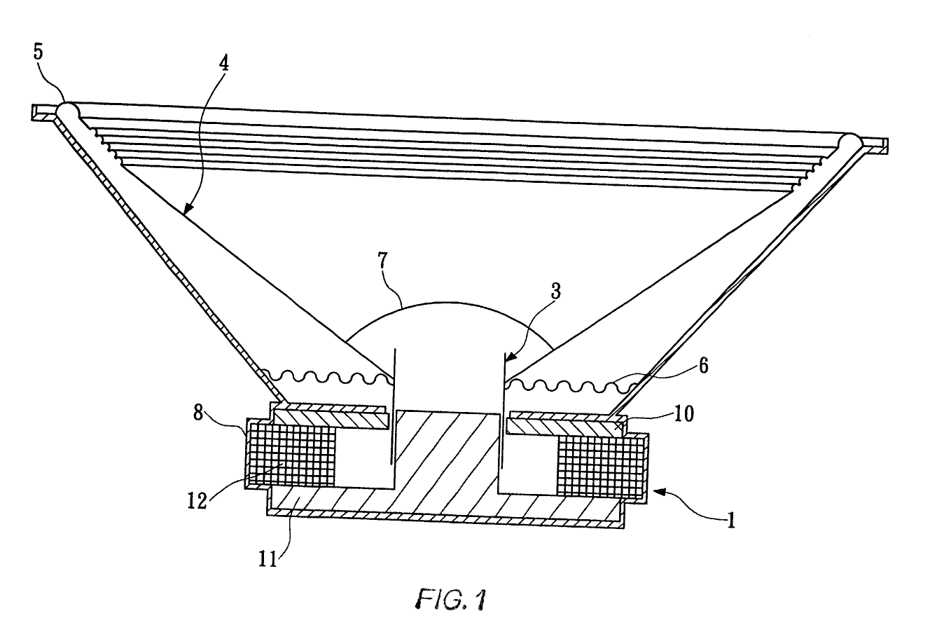

FIG. 2 illustrates the frame of the invention; and

FIG. 3 is the cross-sectional view of the amplifier with improved structure in the invention.

### DETAILED DESCRIPTION OF THE PREFERRED EMBODIMENTS

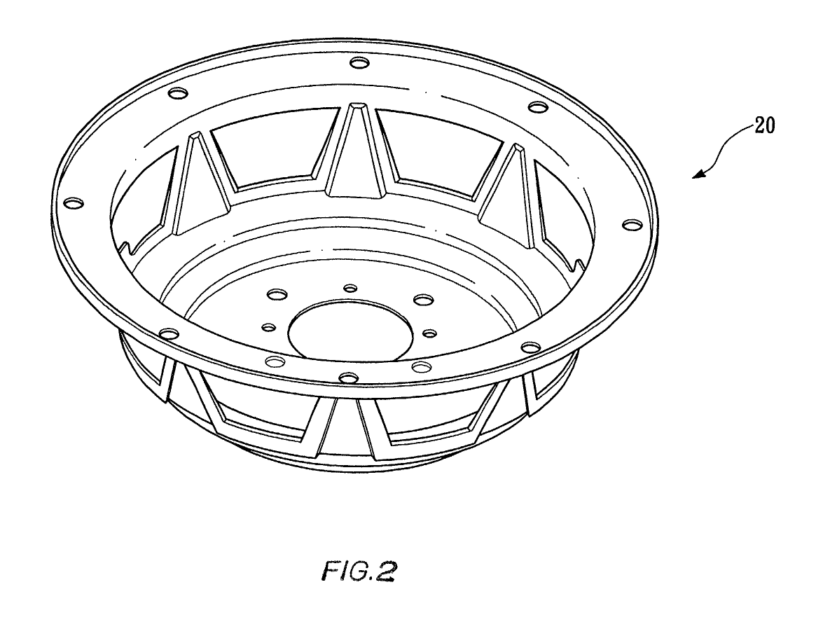

Please refer to FIG. 2, the frame 20 of the invention is a one-body structure produced by injection molding machine (not shown in FIG. 2). The thickness of the frame 20 can be changed to a desirable value in accordance with a specific design. The material used in the frame 20 is thermosetting plastic and thermoplastic. This meets customer's requirement that using such material which is able to be recycled (thermoplastic material) can reduce pollution and protect environment. Different metals or color paints can be coated on the frame 20 by electro-plating or painting, respectively. Furthermore, there are several holes or grooves (not shown in the figure) of complicated shapes distributed around the opening of the frame 20. By using the manufacturing process corresponding to injection molding in the invention, only one die is required to obtain the frame structure which definitely meets the requirement of the customers.

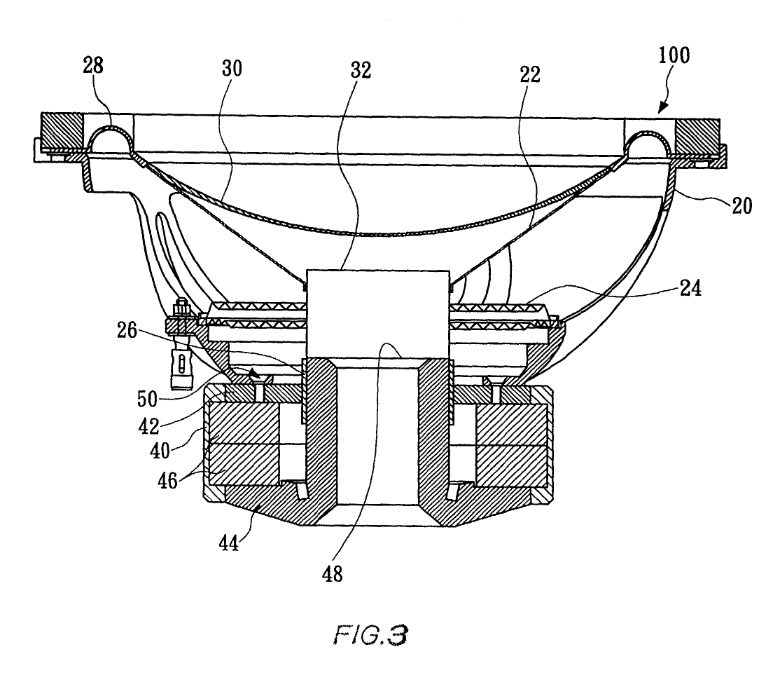

Please refer to FIG. 3, the improved structure of the amplifier 100 of the invention is basically a one-body frame 20 produced by injection molding combined with a base 40 and a package component. The base 40 which is made of non-magnetic material consists of one or more than one magnets 46, a spacer 42, a T-shaped iron 44. The magnet 46 is wrapped and located between the spacer 42 and the T-shaped iron. The T-shaped iron contains an axial shaft for generating magnetic effect and the shaft is as long as it can reach the spacer 42. The spacer 42 is fixed at the bottom of the base 40 by several screws 50.

The package component consists of a cone paper 22, one or more than one damper 24, a heat sink 26, a dust cap 30, a voice coil 48, and a fixed tube 32. The package component is placed inside the frame. The voice coil 48 is placed at the top of the axial shaft. The top portion of the axial shaft is surrounded by heat sink 26. The lower end of the fixed tube is inserted to the space between the heat sink 26 and the voice coil 48. The outer rim of the rubber edge 28 is connected to the frame 20 and the inner rim of the rubber edge 28 is connected to the dust cap 30 and the cone paper 22. Generally speaking, the dust cap 30 is located at the outmost area while the cone paper 22 is located at an interior area below the dust cap 30. This arrangement leaves an empty space between the dust cap 30 and the cone paper 22. Particularly, the cone paper 22 extends from the rubber edge 28 to the top side of the fixed tube 32. Two dampers 24 shown in the FIG. 3 are put around the fixed tube 32 and placed between the bottom portion of the frames and the cone paper 22.

The structure of the amplifier in the invention is different from those conventional ones. More particularly, two dampers 24 are put around the fixed tube 32 in the invention. The cone paper 22 is connected to the upper side of the fixed tube. One heat sink 26 is also placed around the fixed tube. Therefore, the invention can be applied to high power amplifier such as home theater and automobile radio and stereo system.

What is claimed is:

1. An improved structure of amplifier, said amplifier consists of a frame, a base fixed at the bottom of said frame, one or more than one magnet, a spacer, a T-shaped iron, a package component containing one or more than one damper, a cone paper, a heat sink, a rubber edge, a dust cap, a voice coil, a fixed tube, said package component is placed inside said frame, said frames is featured by its one-body structure which is produce by injection molding and made of rubber material.

2. The improved structure of amplifier as claimed in claim 1, wherein the material selected to produce said frame can be thermosetting plastic.

3. The improved structure of amplifier as claimed in claim 1, wherein the material selected to produce said frame can be thermoplastic resin.

4. The improved structure of amplifier as claimed in claim 1, wherein different metals or color paints can be coated on said frame by electro-plating or painting.

5. The improved structure of amplifier as claimed in claim 1, wherein the thickness of said frame can be changed.
